(19) United States
(12) Patent Application Publication
(10) Pub. No.: US 2024/0040291 A1
(43) Pub. Date: Feb. 1, 2024

(54) SPEAKER MODULE AND ELECTRONIC DEVICE INCLUDING SAME

(71) Applicant: SAMSUNG ELECTRONICS CO., LTD., Suwon-si (KR)

(72) Inventors: Myeungseon KIM, Suwon-si (KR); Seongkwan Yang, Suwon-si (KR); Kiwon Kim, Suwon-si (KR); Joonrae Cho, Suwon-si (KR)

(73) Assignee: SAMSUNG ELECTRONICS CO., LTD., Suwon-si (KR)

(21) Appl. No.: 18/380,043

(22) Filed: Oct. 13, 2023

Related U.S. Application Data
(63) Continuation of application No. PCT/KR2022/005345, filed on Apr. 13, 2022.

(30) Foreign Application Priority Data
Apr. 14, 2021 (KR) 10-2021-0048436

(51) Int. Cl. H04R 1/02

(52) U.S. Cl. CPC H04R 1/025; H04R 2400/07; H04R 2499/11

(57) ABSTRACT

An electronic device includes: a first housing that is at least a part of an exterior of the electronic device; and a speaker module located in the first housing. The speaker module includes: a first plate includes a first magnetic material; a first magnet disposed on one surface of the first plate; a center pole connected to the first plate and surrounded by the first magnet; a coil structure includes a coil inserted into a gap between the first magnet and the center pole; a diaphragm connected to the coil structure; a second housing includes an opening corresponding to the diaphragm. The first magnet includes: a first surface coupled to the first plate; and a second surface positioned opposite to the first surface, and wherein the second housing is coupled to a first portion of the second surface.

### CROSS-REFERENCE TO RELATED APPLICATIONS

This application is a by-pass continuation application of International Application No. PCT/KR2022/005345, filed on Apr. 13, 2022, which is based on and claims priority to Korean Patent Application No. 10-2021-0048436, filed on Apr. 14, 2021, in the Korean Intellectual Property Office, the disclosures of which are incorporated by reference herein their entireties.

### BACKGROUND

### 1. Field

The disclosure relates to a speaker module and an electronic device including the same.

### 2. Description of Related Art

An electronic device such as a smart phone, a tablet personal computer (PC), or a personal digital assistant (PDA) may include a speaker module for outputting sound.

As electronic devices become slimmer, it may be difficult to secure the size of magnets included in the speaker module of the electronic device. Because of this, the magnetic force with respect to the magnetic field of the speaker module is not strong enough, and output features (e.g., sound pressures) of the speaker module may be degraded.

### SUMMARY

Provided are a speaker module and an electronic device including the same for easily securing the size of the magnet. Provided are a speaker module and an electronic device including the same for providing magnets having proper sizes, and thus, providing strengths of magnetic fields, which do not degrade the output features.

The technical tasks to be accomplished in the disclosure are not limited to the above-mentioned technical tasks, and other technical tasks not mentioned can be clearly understood by persons of ordinary skill in the art to which the present disclosure pertains from the following description.

According to an aspect of the disclosure, an electronic device includes: a first housing that is at least a part of an exterior of the electronic device; and a speaker module located in the first housing, wherein the speaker module includes: a first plate includes a first magnetic material; a first magnet disposed on one surface of the first plate; a center pole connected to the first plate and surrounded by the first magnet; a coil structure includes a coil inserted into a gap between the first magnet and the center pole; a diaphragm connected to the coil structure; a second housing includes an opening corresponding to the diaphragm, and wherein the first magnet includes: a first surface coupled to the first plate; and a second surface positioned opposite to the first surface, and wherein the second housing is coupled to a first portion of the second surface.

The center pole and the first plate are integrated.

The electronic device further includes a first adhesive material located between the second surface and a second portion of the second housing.

In the electronic device, the first magnet includes a third portion that extends between a second portion of the second housing and the first plate, and wherein the third portion of the first magnet is coupled to the second portion of the second housing.

The electronic device further includes a second plate located on the second surface between the diaphragm and the second surface, and wherein the second plate includes a second magnetic material.

The electronic device further includes a support located between the diaphragm and the second plate.

In the electronic device, a fourth portion of the second housing is located by covering the support.

The electronic device further includes a second adhesive material located between a fifth portion of the second housing and the support.

The first adhesive material and the second adhesive material are integrated.

A sixth portion of the second housing is configured to cover the diaphragm.

The electronic device further includes a third adhesive material located between a seventh portion of the second housing and the diaphragm.

The first adhesive material and the third adhesive material are integrated.

The center pole includes a second magnet.

The center pole includes a third magnetic material.

The center pole further includes a second magnet coupled to the third magnetic material.

The first magnet is a square ring.

A speaker module and an electronic device including the same according to an embodiment of the disclosure can reduce the degradation of the output features (e.g., sound pressure) of the speaker module and contribute to the slimming of the speaker module by securing the size of the magnet.

In addition, effects that may be obtained or predicted by one or more embodiments of the disclosure may be directly or implicitly disclosed in the detailed description of the embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment;

FIG. 2 is a perspective view of the front surface of an electronic device according to an embodiment;

FIG. 3 is a perspective view of the rear surface of the electronic device of FIG. 2 according to an embodiment;

FIG. 4 is an exploded perspective view of the electronic device of FIG. 2 according to an embodiment;

FIG. 5 is a perspective view of a speaker module included in the electronic device of FIG. 2 according to an embodiment;

FIG. 6 is a plan view of the speaker module of FIG. 5 according to an embodiment;

FIG. 7 is an exploded perspective view of the speaker module of FIG. 5 according to an embodiment;

FIG. 8 is a plan view of the second housing of FIG. 7 according to an embodiment;

FIG. 9 illustrates a cross-sectional structure of a speaker module with respect to line A-A′ of FIG. 6 according to an embodiment;

FIG. 10 illustrates a schematic cross-sectional structure of a portion of a speaker module with respect to line A-A′ in FIG. 6 according to an embodiment;

FIG. 11 illustrates a schematic cross-sectional structure of a portion of a speaker module with respect to line A-A′ of FIG. 6 according to an embodiment;

FIG. 12 illustrates a schematic cross-sectional structure of a portion of a speaker module with respect to line A-A′ of FIG. 6 according to an embodiment;

FIG. 13 illustrates a schematic cross-sectional structure of a portion of a speaker module with respect to line A-A′ of FIG. 6 according to an embodiment; and

FIG. 14 illustrates a schematic cross-sectional structure of a portion of a speaker module with respect to line A-A′ of FIG. 6 according to an embodiment.

### DETAILED DESCRIPTION

Hereinafter, various embodiments disclosed herein will be described with reference to the accompanying drawings.

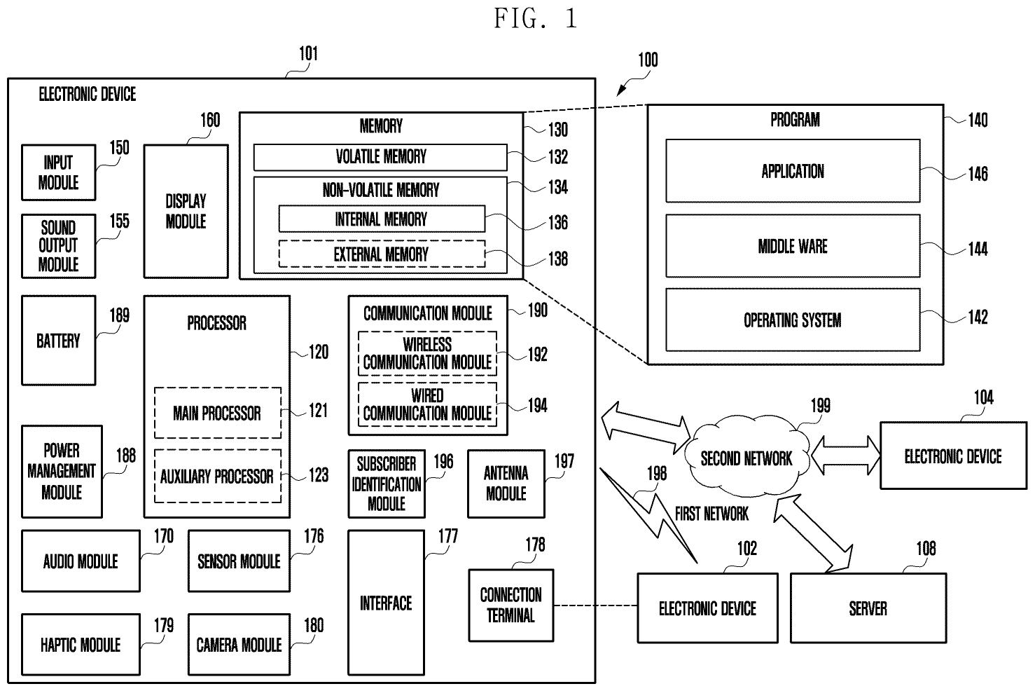

FIG. 1 is a block diagram of an electronic device 101 in a network environment 100 according to an embodiment.

With reference to FIG. 1, the electronic device 101 in the network environment 100 may communicate with an external electronic device 102 via a first network 198 (e.g., a short-range wireless communication network), or at least one of an external electronic device 104 or a server 108 via a second network 199 (e.g., a long-range wireless communication network). The electronic device 101 may communicate with the external electronic device 104 via the server 108. The electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, and/or an antenna module 197. In some embodiments of the disclosure, at least one (e.g., the connection terminal 178) of the components may be omitted from the electronic device 101, or one or more other components may be added in the electronic device 101. In some embodiments of the disclosure, some of the components may be implemented as single integrated circuitry. For example, the sensor module 176, the camera module 180, or the antenna module 197 may be implemented as embedded in single component (e.g., the display module 160).

The processor 120 may execute, for example, software (e.g., a program 140) to control at least one other component (e.g., a hardware or software component) of the electronic device 101 coupled with the processor 120, and may perform various data processing or computation. As at least part of the data processing or computation, the processor 120 may load a command or data received from another component (e.g., the sensor module 176 or the communication module 190) in a volatile memory 132, process the command or the data stored in the volatile memory 132, and store resulting data in a non-volatile memory 134. The processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control, for example, at least some of functions or states related to at least one component (e.g., the display module 160, the sensor module 176, or the communication module 190) among the components of the electronic device 101, instead of the main processor 121 while the main processor 121 is in an inactive (e.g., a sleep) state, or together with the main processor 121 while the main processor 121 is in an active state (e.g., executing an application). The auxiliary processor 123 (e.g., an ISP or a CP) may be implemented as part of another component (e.g., the camera module 180 or the communication module 190) functionally related to the auxiliary processor 123. According to an embodiment of the disclosure, the auxiliary processor 123 (e.g., a neural network processing device) may include a hardware structure specified for processing an artificial intelligence model. The artificial intelligence model may be created through machine learning. Such learning may be performed, for example, in the electronic device 101 itself on which the artificial intelligence model is performed, or may be performed through a separate server (e.g., the server 108). The learning algorithms may include, for example, supervised learning, unsupervised learning, semi-supervised learning, or reinforcement learning, but is not limited thereto. The artificial intelligence model may include a plurality of artificial neural network layers. The artificial neural network may be any of a deep neural network (DNN), a convolutional neural network (CNN), a recurrent neural network (RNN), a restricted Boltzmann machine (RBM), a deep belief network (DBN), a bidirectional recurrent DNN (BRDNN), a deep Q-network, or a combination of two or more of the above-mentioned networks, but is not limited the above-mentioned examples. In addition to the hardware structure, the artificial intelligence model may additionally or alternatively include a software structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 and/or the non-volatile memory 134.

The program 140 may be stored in the memory 130 as software, and may include, for example, an operating system (OS) 142, middleware 144, and/or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record, and the receiver may be used for incoming calls. The receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. The display module 160 may include touch circuitry (e.g., a touch sensor) adapted to detect a touch, or sensor circuitry (e.g., a pressure sensor) adapted to measure the intensity of force incurred by the touch.

The audio module 170 may convert a sound into an electrical signal and vice versa. The audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. The sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. The interface 177 may include, for example, a high-definition multimedia interface (HDMI), a universal serial bus (USB) interface, a secure digital (SD) card interface, and/or an audio interface.

The connecting terminal 178 may include a connector via which the electronic device 101 may be physically connected with the external electronic device (e.g., the external electronic device 102). The connecting terminal 178 may include, for example, an HDMI connector, a USB connector, an SD card connector, and/or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. The haptic module 179 may include, for example, a motor, a piezoelectric element, or an electric stimulator.

The camera module 180 may capture a still image or moving images. The camera module 180 may include one or more lenses, image sensors, ISPs, or flashes.

The power management module 188 may manage power supplied to or consumed by the electronic device 101. The power management module 188 may be implemented as at least part of, for example, a power management integrated circuit (PMIC).

The battery 189 may supply power to at least one component of the electronic device 101. The battery 189 may include, for example, a primary cell which is not rechargeable, a secondary cell which is rechargeable, and/or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more CPs that are operable independently from the processor 120 (e.g., the AP) and supports a direct (e.g., wired) communication or a wireless communication. The communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as BLUETOOTH, wireless-fidelity (Wi-Fi) direct, or IR data association (IrDA)) or the second network 199 (e.g., a long-range communication network, such as a legacy cellular network, a 5th generation (5G) network, a next generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network, after a 4th generation (4G) network, and next-generation communication technology, e.g., new radio (NR) access technology. The NR access technology may support high-speed transmission of high-capacity data (i.e., enhanced mobile broadband (eMBB)), minimization of terminal power and connection of multiple terminals (massive machine type communications (mMTC)), or high reliability and low latency (ultra-reliable and low-latency communications (URLLC)). The wireless communication module 192 may support a high-frequency band (e.g., a mmWave band) to achieve, for example, a high data transmission rate. The wireless communication module 192 may support various technologies for securing performance in a high-frequency band, such as beamforming, massive multiple-input and multiple-output (MIMO), full-dimensional MIMO (FD-MIMO), array antenna, analog beam-forming, or large-scale antenna. The wireless communication module 192 may support various requirements specified in the electronic device 101, an external electronic device (e.g., external the electronic device 104), or a network system (e.g., the second network 199). According to an embodiment of the disclosure, the wireless communication module 192 may support a peak data rate for implementing eMBB (e.g., 20 Gbps or more), loss coverage for implementing mMTC (e.g., 164 dB or less), or U-plane latency for realizing URLLC (e.g., 0.5 ms or less for each of downlink (DL) and uplink (UL) or Tms or less for round trip).

The antenna module 197 may transmit or receive a signal or power to or from the outside (e.g., the external electronic device) of the electronic device 101. The antenna module 197 may include an antenna including a radiating element including a conductive material or a conductive pattern formed in or on a substrate (e.g., a printed circuit board (PCB)). The antenna module 197 may include a plurality of antennas (e.g., an antenna array). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. Another component (e.g., a radio frequency integrated circuit (RFIC)) other than the radiating element may be additionally formed as part of the antenna module 197.

According to various embodiments of the disclosure, the antenna module 197 may form a mmWave antenna module. According to an embodiment of the disclosure, the mmWave antenna module may include a PCB, an RFIC that is disposed on or adjacent to a first surface (e.g., the bottom surface) of the PCB and is capable of supporting a predetermined high-frequency band (e.g., a mmWave band), and a plurality of antennas (e.g., array antennas) that is disposed on or adjacent to a second surface (e.g., the top surface or the side surface) of the PCB and is capable of transmitting or receiving a signal of the predetermined high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

Commands or data may be transmitted or received between the electronic device 101 and the external electronic device 104 via the server 108 coupled with the second network 199. Each of the external electronic devices 102 or 104 may be a device of a same type as, or a different type, from the electronic device 101. All or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide an ultra-low delay service using, for example, distributed computing or MEC. In another embodiment of the disclosure, the external electronic device 104 may include an internet of things (IoT) device. The server 108 may be an intelligent server using machine learning and/or neural networks. According to an embodiment of the disclosure, the external electronic device 104 or the server 108 may be included in the second network 199. The electronic device 101 may be applied to an intelligent service (e.g., smart home, smart city, smart car, or healthcare) based on 5G communication technology or IoT-related technology.

An electronic device according to an embodiment of the disclosure may be one of various types of electronic devices. The electronic devices may include a portable communication device (e.g., a smartphone), a computer device, a portable multimedia device, a portable medical device, a camera, a wearable device, or a home appliance. However, the electronic device is not limited to any of those described above.

Various embodiments of the disclosure and the terms used herein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). If an element (e.g., a first element) is referred to, with or without the term “operatively” or “communicatively,” as “coupled with,” “coupled to,” “connected with,” or “connected to” another element (e.g., a second element), it means that the element may be coupled with the other element directly (e.g., wiredly), wirelessly, or via a third element.

The term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment of the disclosure, the module may be implemented in a form of an application-specific integrated circuit (ASIC).

Various embodiments as set forth herein may be implemented as software (e.g., the program 140) including one or more instructions that are stored in a storage medium (e.g., an internal memory 136 or an external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

A method according to an embodiment of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PLAYSTORE™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

Each component (e.g., a module or a program) of the above-described components may include a single entity or multiple entities. One or more of the above-described components may be omitted, or one or more other components may be added. Alternatively or additionally, a plurality of components (e.g., modules or programs) may be integrated into a single component. In such a case, the integrated component may perform one or more functions of each of the plurality of components in the same or similar manner as they are performed by a corresponding one of the plurality of components before the integration. Operations performed by the module, the program, or another component may be carried out sequentially, in parallel, repeatedly, or heuristically, or one or more of the operations may be executed in a different order or omitted, or one or more other operations may be added.

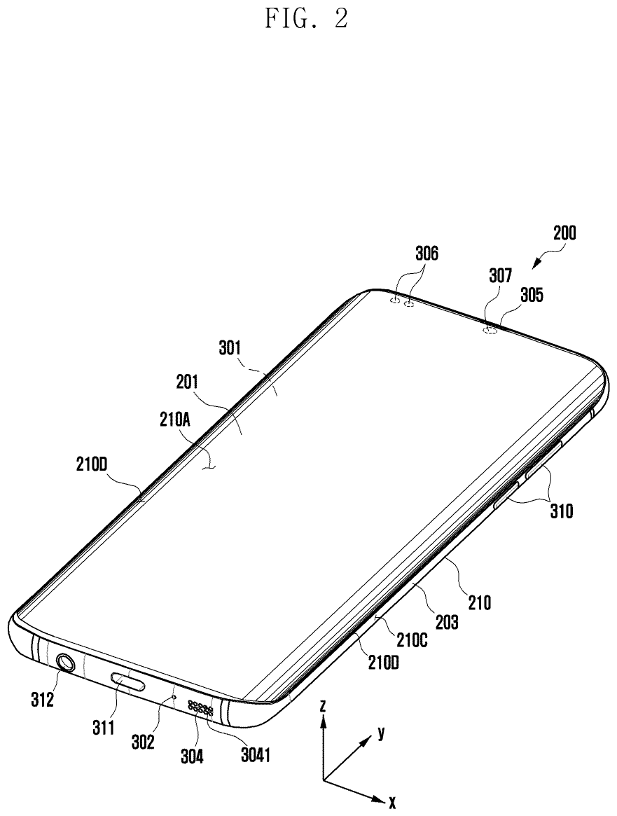

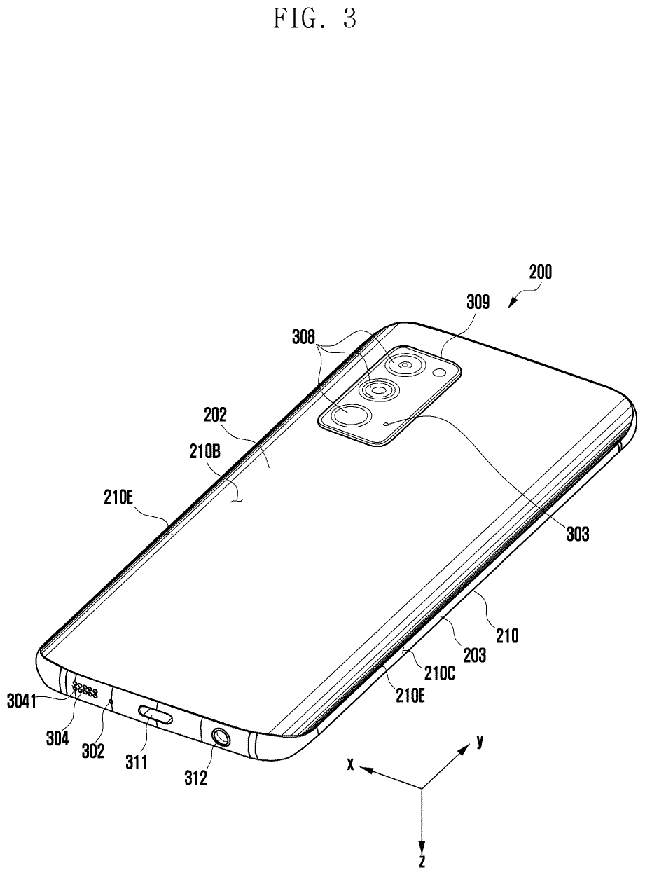

FIG. 2 is a perspective view of the front surface of an electronic device 200 according to an embodiment. FIG. 3 is a perspective view of the rear surface of the electronic device 200 of FIG. 2 according to an embodiment.

With reference to FIGS. 2 and 3, in an embodiment, the electronic device 200 (e.g., the electronic device 101 of FIG. 1) may include the first housing 210 that includes the first surface (or the front surface) 210A, the second surface (or the rear surface) 210B, and the side surface 210C surrounding the space between the first surface 210A and the second surface 210B. In some embodiments, the first housing 210 may refer to a structure that provides at least a portion of the first surface 210A, the second surface 210B, and the side surface 210C. The first surface 210A may be provided by at least a partially transparent front plate (or a first plate) 201 (e.g., a glass plate or a polymer plate comprising various coating layers). The second surface 210B may be provided by a substantially opaque rear plate (or a second plate) 202. The rear plate 202 may be provided, for example, by a coated or colored glass, a ceramic, a polymer, a metal (e.g., an aluminum, a stainless steel (STS), or a magnesium), or a combination of at least two of the above materials. The side surface 210C may be provided by a side bezel structure (or “a lateral member”) 203 coupled to the front plate 201 and the rear plate 202, and the side bezel structure 203 may include a metal and/or a polymer. In some embodiments, the rear plate 202 and the side bezel structure 203 may be provided as one and may include the same material (e.g., a metal material such as an aluminum).

In an embodiment, the front plate 201 may include two first areas 210D that are curved from the first surface 210A toward the rear plate 202 and extended seamlessly. The first areas 210D may be provided adjacent to each of the long edges on both sides of the front plate 201. The rear plate 202 may include two second areas 210E that are curved from the second surface 210B toward the front plate 201 and extended seamlessly. The second areas 210E may be provided adjacent to each of the long edges of on both sides of the rear plate 202. The side surface 210C may have a first thickness (or a width) (e.g., a height in the z-axis direction) on the side where the first areas 210D and the second areas 210E are not located, and the first areas 210D and the second areas 210E may have a second thickness smaller than the first thickness on the side where the first areas 210D and the second areas 210E are located. In some embodiments, the front plate 201 may be implemented including one of the first areas 210D or may be implemented without curved first areas 210D. In some embodiments, the rear plate 202 may be implemented including one of the second areas 210E or may be implemented without curved second areas 210E.

According to an embodiment, the electronic device 200 may include at least one of a display 301, a first audio module 302, a second audio module 303, a third audio module 304, a fourth audio module 305, a sensor module 306, a first camera module 307, a plurality of second camera modules 308, a light-emitting module 309, an input module 310, a first connection terminal module 311, or a second connection terminal module 312. In some embodiments, the electronic device 200 may omit at least one of the above-described components or additionally include other components.

According to an embodiment, the display area (e.g., a screen display area or an active area) of the display 301 may be visually exposed, for example, through the front plate 201. In an embodiment, the electronic device 200 may be implemented to maximize the display area visible through the front plate 201 (e.g., a large screen or a full screen). In one embodiment, the display 301 may be implemented to have an outer periphery of the approximately same shape as that of the front plate 201. For another example, the space between the outer periphery of the display 301 and the outer periphery of the front plate 201 may be provided to be approximately the same. In an embodiment, the display 301 may include a touch sensing circuitry. In some embodiments, the display 301 may include a pressure sensor capable of measuring the intensity (pressure) of the touch. In some embodiments, the display 301 may be coupled to or located adjacent to the digitizer (e.g., an electromagnetic induction panel) that detects a magnetic field type electronic pen (e.g., a stylus pen).

According to an embodiment, the first audio module 302 may include, for example, a first microphone located inside the electronic device 200 and a first microphone hole provided on the side surface 210C corresponding to the first microphone. The second audio module 303 may include, for example, a second microphone (or a second microphone module) located inside the electronic device 200 and a second microphone hole provided on the second surface 210B corresponding to the second microphone. The position or number of audio modules with respect to the microphone may vary without limitation to the illustrated examples. In some embodiments, the electronic device 200 may include a plurality of microphones used to sense the direction of sound.

According to an embodiment, the third audio module 304 may include, for example, a first speaker (or a first speaker module) located inside the electronic device 200 and a first speaker hole 3041 provided on the side surface 210C corresponding to the first speaker. The fourth audio module 305 may include, for example, a second speaker (or a second speaker module) located inside the electronic device 200 and a second speaker hole provided on the first surface 210A corresponding to the second speaker. In an embodiment, the first speaker may include an external speaker. In an embodiment, the second speaker may include a receiver for calling and the second speaker hole may be referred to as a receiver hole. The location or number of the third audio module 304 or the fourth audio module 305 may vary without limitation to the illustrated examples. In some embodiments, the microphone hole and the speaker hole may be implemented as one hole. In some embodiments, the third audio module 304 or the fourth audio module 305 may include a piezo speaker with a speaker hole omitted.

According to an embodiment, the sensor module 306 may generate an electrical signal or data value corresponding to, for example, an internal operating state of the electronic device 200 or an external environmental state. In an embodiment, the sensor module 306 may include an optical sensor located inside the electronic device 200 corresponding to the first surface 210A. The optical sensor may include, for example, a proximity sensor or an illuminance sensor. The optical sensor may be aligned with the opening provided in the display 301. External light may enter the optical sensor through the opening of the front plate 201 and the display 301. In some embodiments, the optical sensor may be disposed at the bottom of the display 301 and the position of the optical sensor may perform a related function without being visually distinguished (or exposed). In one embodiment, the optical sensor may be located on the rear surface of the display 301 or below or beneath the display 301. In some embodiments, the optical sensor may be aligned and positioned on the recess provided on the rear surface of the display 301. The optical sensor may be disposed overlapping with at least a portion of the screen to perform a sensing function without being exposed to the outside. In this case, some areas of the optical sensor and at least some overlapping display 301 may include different pixel structures and/or wiring structures compared to other areas. In one embodiment, some areas of the optical sensor and at least some overlapping display 301 may have different pixel densities compared to other areas. In some embodiments, a plurality of pixels may not be disposed in some areas of the display 301 that at least partially overlap with the optical sensor. In some embodiments, the electronic device 200 may include a biometric sensor (e.g., a fingerprint sensor) located below the display 301. The biosensor may be implemented by optical, electrostatic, or ultrasonic methods, and the location or number thereof may vary. The electronic device 200 may further include at least one of various other sensor modules, such as a gesture sensor, a gyro sensor, a barometric pressure sensor, a magnetic sensor, an acceleration sensor, a grip sensor, a color sensor, an infrared (IR) sensor, a temperature sensor, or a humidity sensor.

According to an embodiment, the first camera module 307 (e.g., the front camera module) may be located, for example, inside the electronic device 200 corresponding to the first surface 210A. A plurality of second camera modules 308 (e.g., rear camera modules) may be located, for example, inside the electronic device 200 corresponding to the second surface 210B. The first camera module 307 and/or a plurality of second camera modules 308 may include one or more lenses, an image sensor, and/or an image signal processor. The location or number of the first camera module or the second camera module may vary without limitation to the illustrated examples.

According to an embodiment, the display 301 may include an opening aligned with the first camera module 307. The external light may reach the first camera module 307 through the opening of the front plate 201 and the display 301. In some embodiments, the opening of the display 301 may be provided in the form of a notch depending on the position of the first camera module 307. In some embodiments, the first camera module 307 may be disposed at the bottom of the display 301, and the position of the first camera module 307 may perform a related function (e.g., an image shooting) without being visually distinguished (or exposed). In one embodiment, the first camera module 307 may be located on the rear surface of the display 301 or below or beneath the display 301 and may include a hidden display rear camera (e.g., an under display camera (UDC)). In some embodiments, the first camera module 307 may be aligned and positioned on the recess provided on the rear surface of the display 301. The first camera module 307 may be disposed overlapping with at least a portion of the screen to acquire an image of an external subject without being visually exposed to the outside. In this case, some areas of the first camera module 307 and at least some overlapping display 301 may include different pixel structures and/or wiring structures compared to other areas. In one embodiment, some areas of the first camera module 307 and at least some overlapping display 301 may have different pixel densities compared to other areas. The pixel structure and/or wiring structure provided in some areas of the first camera module 307 and at least some overlapping display 301 may reduce the loss of light between the external and the first camera module 307. In some embodiments, pixels may not be disposed in some areas of the first camera module 307 and at least some overlapping display 301. In some embodiments, the electronic device 200 may further include a light-emitting module (e.g., a light source) located inside the electronic device 200 corresponding to the first surface 210A. The light-emitting module, for example, may provide state information of the electronic device 200 in the form of a photo. In some embodiments, the light-emitting module may provide a light source that is interworked with the operation of the first camera module 307. The light-emitting module may include, for example, an LED, an IR LED, or a xenon lamp.

According to an embodiment, a plurality of second camera modules 308 may have different attributes (e.g., an angle of view) or functions, and may include, for example, dual cameras or triple cameras. The plurality of second camera modules 308 may include a plurality of camera modules comprising lenses having different angles of view, and the electronic device 200 may control to change the angle of view of the camera module performed in the electronic device 200 based on the user's selection. The plurality of second camera modules 308 may include at least one of a wide-angle camera, a telephoto camera, a color camera, a monochrome camera, or an infrared camera (e.g., a time of flight (TOF) camera, a structured light camera). In some embodiments, the IR camera may operate as at least part of the sensor module. The light-emitting module 309 (e.g., a flash) may include a light source for a plurality of second camera modules 308. The light-emitting module 309 may include, for example, an LED or a xenon lamp.

According to an embodiment, the input module 310 may include, for example, one or more key input devices. One or more key input devices may be located, for example, in the opening provided on the side surface 210C. In some embodiments, the electronic device 200 may not include some or all of the key input devices, and the key input device, which is not included in the electronic device, may be implemented as a soft key using the display 301. The location or number of input modules 310 may vary, and in some embodiments, the input module 310 may include at least one sensor module.

According to an embodiment, the first connection terminal module 311 (e.g., a first connector module or a first interface terminal module) may include, for example, a first connector (or a first interface terminal) located inside the electronics 200 and a first connector hole formed on the side surface 210C corresponding to the first connector. The second connection terminal module 312 (e.g., a second connector module or a second interface terminal module) may include, for example, a second connector (or a second interface terminal) located inside the electronics 200 and a second connector hole provided on the side surface 210C corresponding to the second connector. The electronic device 200 may transmit and/or receive power and/or data with an external electronic device electrically connected to the first connector or the second connector. In an embodiment, the first connector may include a universal serial bus (USB) connector or a high definition multimedia interface (HDMI) connector. In an embodiment, the second connector may include an audio connector (e.g., a headphone connector or an ear set connector). The location or number of connection terminal modules may vary without limitation to the illustrated examples.

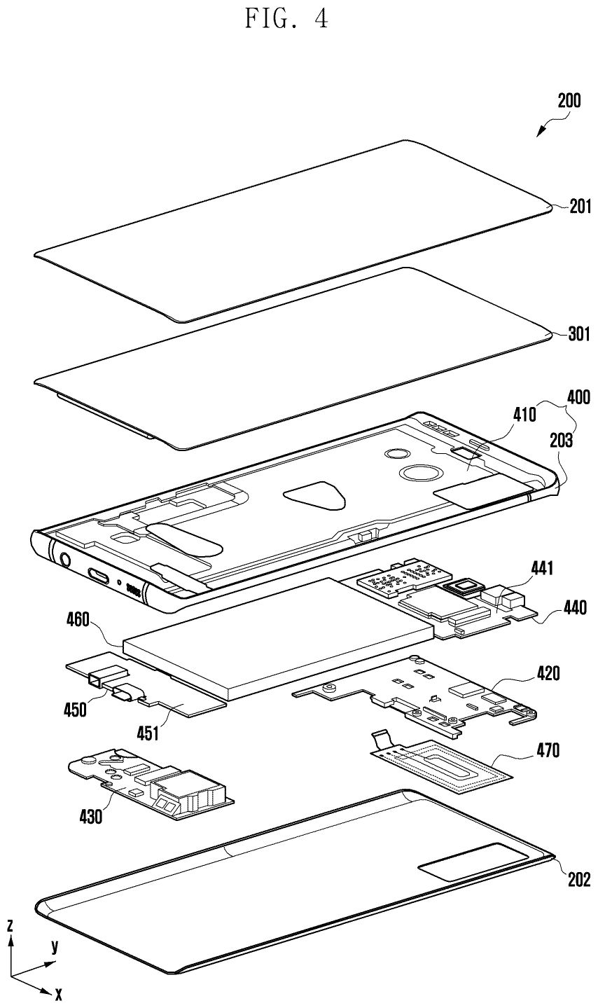

FIG. 4 is an exploded perspective view of the electronic device 200 of FIG. 2 according to an embodiment.

With reference to FIG. 4, in an embodiment, the electronic device 200 may include a front plate 201, a rear plate 202, a side bezel structure 203, a first support member (or, a first support or a first support structure) 410, a second support member (or, a second support or a second support structure) 420, a third support member 430 (or, a third support or a third support structure), a display 301, a first substrate assembly 440, a second substrate assembly 450, a battery 460, or an antenna structure 470. In some embodiments, the electronic device 200 may omit at least one of the components (e.g., a second support member 420 or a third support member 430) or additionally include another components.

The first support member 410 may be located, for example, inside the electronic device 200 and connected to the side bezel structure 203, or may be integrated with the side bezel structure 203. The first support member 410 may be formed, for example, of a metal material and/or a non-metal material (e.g., a polymer). In an embodiment, the conductive portion included in the first support member 410 may serve as an electromagnetic shield for the display 301, the first substrate assembly 440, and/or the second substrate assembly 450. It may be referred to as a front case 400, including a first support member 410 and a side bezel structure 203. The first support member 410 may contribute to the durability or rigidity (e.g., torsional rigidity) of the electronic device 200 as a portion of the front case 400 in which components such as the display 301, the first substrate assembly 440, the second substrate assembly 450, or the battery 460 are disposed. Hereinafter, the first support member 410 may be referred to as a support structure (e.g., a bracket or a mounting plate).

The display 301 may be located, for example, between the first support member 410 and the front plate 201 and may be disposed on one surface of the first support member 410. The first substrate assembly 440 and the second substrate assembly 450 may be located, for example, between the first support member 410 and the rear plate 202 and may be disposed on the other surface of the first support member 410. The battery 460 may be, for example, located between the first support member 410 and the rear plate 202 and may be disposed on the first support member 410.

According to an embodiment, the first substrate assembly 440 may include a first printed circuit board 441 (e.g., a printed circuit board (PCB), or a printed circuit board assembly (PBA)). The first substrate assembly 440 may include various electronic components electrically connected to the first printed circuit board 441. The electronic components may be disposed on the first printed circuit board 441 or electrically connected to the first printed circuit board 441 through an electrical path such as a cable or a flexible printed circuit board (FPCB). With reference to FIGS. 2 and 3, the electronic components may include, for example, a second microphone included in the second audio module 303, a second speaker included in the fourth audio module 305, a sensor module 306, a first camera module 307, a plurality of second camera modules 308, a light-emitting module 309, or an input module 310.

According to an embodiment, the second substrate assembly 450 may be disposed apart from the first substrate assembly 440 having the battery 460 in between when viewed from the top of the front plate 201 (e.g., in the direction of the −z-axis). The second substrate assembly 450 may include a second printed circuit board 451 electrically connected to the first printed circuit board 441 of the first substrate assembly 440. The second substrate assembly 450 may include various electronic components electrically connected to the second printed circuit board 451. The electronic components may be disposed on the second printed circuit board 451 or electrically connected to the second printed circuit board 451 via an electrical path such as a cable or FPCB. With reference to FIGS. 2 and 3, the electronic components may include, for example, a first microphone (or a first microphone module) included in the first audio module 302, a first speaker included in the third audio module 304, a first connector included in the first connection terminal module 311, or a second connector included in the second connection terminal module 312.

According to some embodiments, the first substrate assembly 440 or the second substrate assembly 450 may include a primary PCB (or a main PCB or a master PCB), a secondary PCB (or a slaver PCB) partially overlapped with the primary PCB, and/or an interposer substrate between the primary PCB and the secondary PCB.

According to an embodiment, the battery 460, as a device for supplying power to at least one component of the electronic device 200, may include, for example, a non-rechargeable primary cell, a rechargeable secondary cell, or a fuel cell. The battery 460 may be integrally disposed inside the electronic device 200 or may be detachably disposed with the electronic device 200.

According to an embodiment, the second support member 420 may be located between the first support member 410 and the rear plate 202 and may be coupled to the first support member 410 using a fastening element such as a bolt. At least a portion of the first substrate assembly 440 may be located between the first support member 410 and the second support member 420, and the second support member 420 may cover and protect the first substrate assembly 440. The third support member 430 may be located at least partially apart from the second support member 420 when viewed from the top of the rear plate 202 (e.g., in the direction of the +z-axis). The third support member 430 may be located between the first support member 410 and the rear plate 202 and may be coupled to the first support member 410 using a fastening element such as a bolt. At least a portion of the second substrate assembly 450 may be located between the first support member 410 and the third support member 430, and the third support member 430 may cover and protect the second substrate assembly 450. The second supporting member 420 and/or the third supporting member 430 may be formed of a metal material and/or a non-metal material (e.g., a polymer). In some embodiments, the second support member 420 may serve as an electromagnetic shield for the first substrate assembly 440, and the third support member 430 may serve as an electromagnetic shield for the second substrate assembly 450. In some embodiments, the second support member 420 and/or the third support member 430 may be referred to as a rear case.

According to some embodiments, an integrated substrate assembly including a first substrate assembly 440 and a second substrate assembly 450 may be implemented. In one embodiment, when viewed from the top of the rear plate 202 (e.g., in the direction of the +z-axis), the substrate assembly may include a first and second portions located apart from each other with the battery 460 in between, and a third portion extending between the battery 460 and the side bezel structure 203 and connecting the first and second portions. The third portion may be implemented practically rigidly. In some embodiments, the third portion may be implemented substantially flexibly. In some embodiments, any support member including a second support member 420 and a third support member 430 may be implemented.

According to an embodiment, the antenna structure 470 may be located between the second support member 420 and the rear plate 202. In some embodiments, the antenna structure 470 may be located between the battery 460 and the rear plate 202. The antenna structure 470 may be implemented in the form of a film, for example, a FPCB. The antenna structure 470 may include at least one conductive pattern utilized as a loop-type emitter. In one embodiment, the at least one conductive pattern may include a planar spiral conductive pattern (e.g., a planar coil, or a pattern coil). In an embodiment, at least one conductive pattern included in the antenna structure 470 may be electrically connected to a wireless communication circuit (or a wireless communication module) included in the first substrate assembly 440. For example, at least one conductive pattern may be utilized for short-range wireless communication such as near field communication (NFC). For another example, at least one conductive pattern may be utilized for magnetic secure transmission (MST) for transmitting and/or receiving a magnetic signal. In some embodiments, at least one conductive pattern included in the antenna structure 470 may be electrically connected to the power transmission and reception circuit included in the first substrate assembly 440. The power transmission and reception circuit may wirelessly receive power from an external electronic device using at least one conductive pattern, or wirelessly transmit power to an external electronic device. The power transmission and reception circuit may include a power management module, for example, a power management integrated circuit (PMIC), or a charger integrated circuit (IC). The power transmission and reception circuit may charge the battery 460 using the power received wirelessly using a conductive pattern.

The electronic device 200 may further include various components depending on the form of its provision. These components vary in variation according to the convergence trend of the electronic device 200 and cannot be enumerated all, but additional components equivalent to the above-mentioned components may be additionally included in the electronic device 200. In one or more embodiments, certain components may be excluded from the above components or replaced by other components, depending on the form of provision.

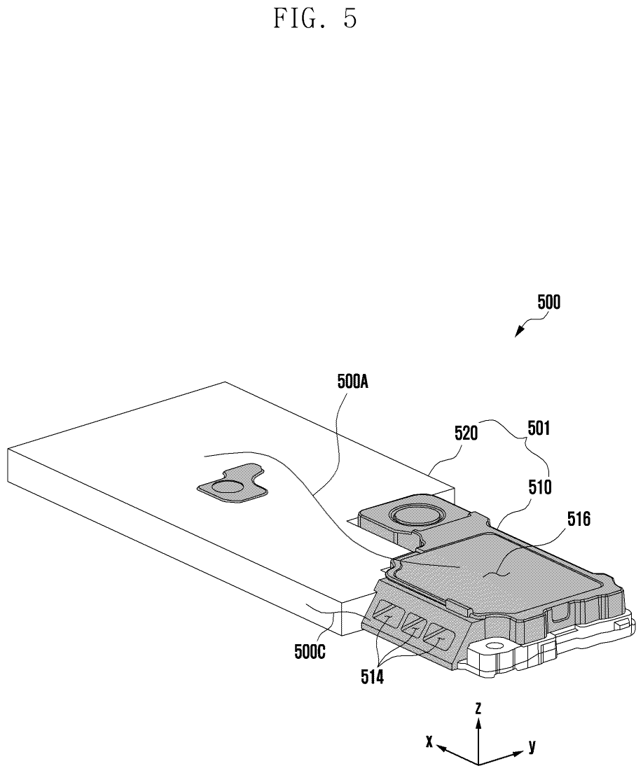

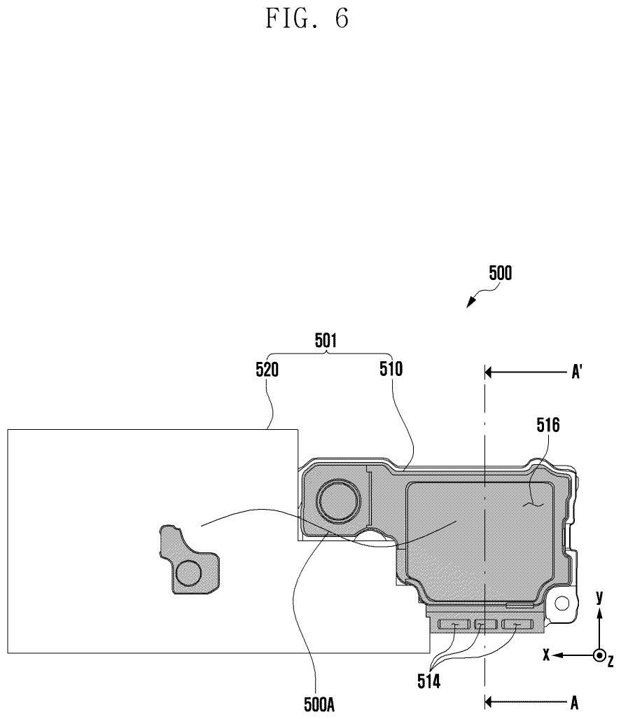

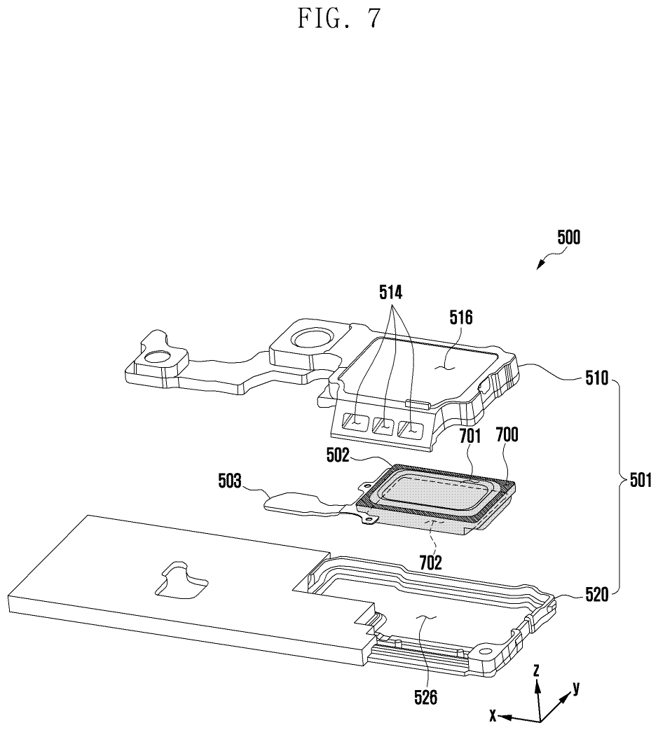

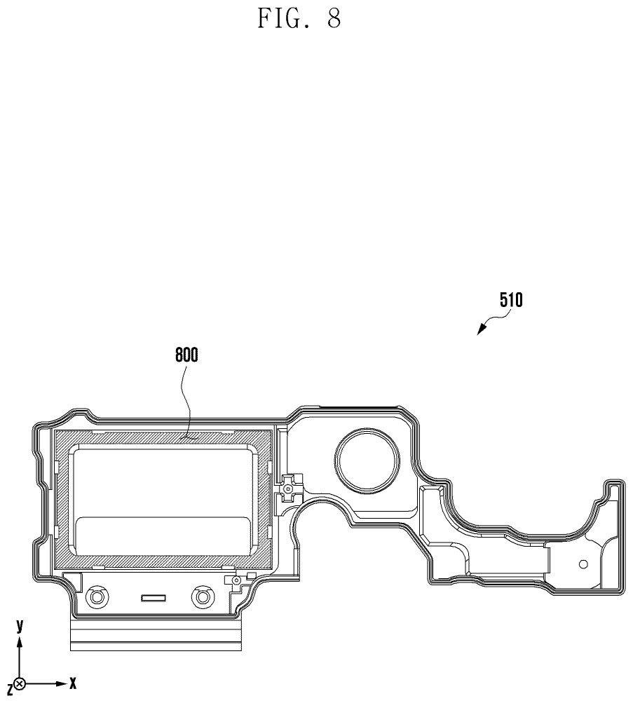

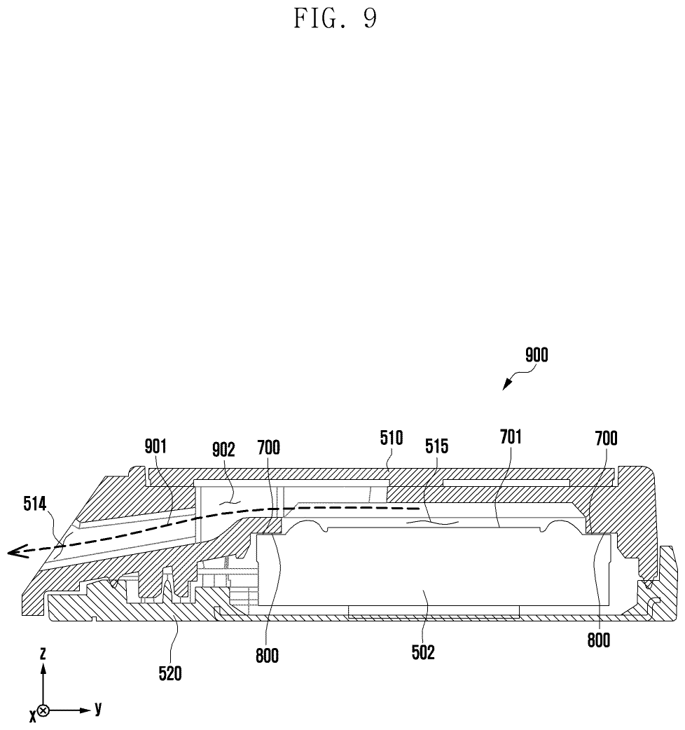

FIG. 5 is a perspective view of a speaker module 500 included in the electronic device 200 of FIG. 2 according to an embodiment. FIG. 6 is a plan view of the speaker module 500 of FIG. 5 in an embodiment. FIG. 7 is an exploded perspective view of the speaker module 500 of FIG. 5 in an embodiment. FIG. 8 is a plan view of the second housing 510 of FIG. 7 in an embodiment. FIG. 9 illustrates a cross-sectional structure 900 of a speaker module 500 with respect to line A-A′ of FIG. 6 in an embodiment.

With reference to FIGS. 5, 6, 7, 8, and 9, in an embodiment, the speaker module (or a speaker assembly) 500 may include a housing structure 501, a speaker 502, and/or an electrical path 503. The speaker module 500 may be located inside the electronic device 200 or the first housing 210 of FIG. 2 or 3. In an embodiment, the housing structure 501 may be disposed of or coupled to the first support member 410 (refer to FIG. 4) of the front case 400. In some embodiments, the housing structure 501 may be disposed of or coupled to the second printed circuit board 451 (refer to FIG. 4). In one embodiment, the housing structure 501 may be coupled to the front case 400 or the second printed circuit board 451 using various fastening elements such as bolt fastening. The housing structure 501 may provide at least a portion of the appearance of the speaker module 500, and the speaker 502 may be located in the inner space of the housing structure 501. The electrical path 503 may electrically connect the speaker 502 and the second printed circuit board 451. One end of the electrical path 503 may be connected to the speaker 502, and the other end of the electrical path 503 may be electrically connected to the second printed circuit board 451 outside the housing structure 501. The housing structure 501 may include, for example, a through-hole that allows the electrical path 503 to be penetrated and located. The electrical path 503 may include, for example, a flexible printed circuit board (FPCB).

According to an embodiment, the speaker module 500 may be included in a third audio module 304 (refer to FIG. 2 or 3). In one embodiment, the housing structure 501 may include a first opening 514, and the sound generated by the speaker 502 may be emitted out of the housing structure 501 through the first opening 514. The first opening 514 may be located corresponding to the first speaker hole 3041 (refer to FIG. 2 or 3). The housing structure 501 may include a passage structure 902 (refer to FIG. 9) for guiding the sound generated by the speaker 502 to the first opening 514. The front case 400 (refer to FIG. 4) may include a first hole structure including a first speaker hole 3041 (refer to FIG. 2 or 3), and the first hole structure may be a passage structure 902 (e.g., a second hole structure) (refer to FIG. 9) that provides the first opening 514 of the housing structure 501. In an embodiment, a flexible member (or a flexible material) such as a rubber may be elastically disposed between the first hole structure and the passage structure 902. The flexible member may contribute to preventing sound from leaking between the first hole structure and the passage structure 902. The flexible member may contribute to preventing foreign substances such as water or dust introduced from the outside into the first speaker hole 3041 (refer to FIG. 2 or 3) from entering the interior of the electronic device 200 through the first hole structure and the passage structure 902 (e.g., a waterproof structure).

According to an embodiment, the housing structure 501 may provide a front portion 500A of the speaker module 500, a rear portion of the speaker module 500, or a side portion 500C of the speaker module 500. The front portion 500A and the rear portion may be located substantially opposite sides, and the side portion 500C may surround at least portion of the space between the front portion 500A and the rear portion. In an embodiment, the first opening 514 may be provided at least a portion of the side portion 500C. In an embodiment, the front portion 500A may be directed to the front plate 201 (refer to FIG. 4) of the electronic device 200, and the rear portion may be directed to the rear plate 202 (refer to FIG. 4) of the electronic device 200. In some embodiments, the speaker module 500 may be located in the electronic device 200 so that the front portion 500A is directed to the rear plate 202 of the electronic device 200 and the rear portion is directed to the front plate 201 of the electronic device 200.

According to an embodiment, the housing structure 501 may include a second housing 510 and a third housing 520. The second housing 510 and the third housing 520 may be coupled by a mechanical fastening method such as a bolt or snap-fit, or by bonding using an adhesive material (or an adhesive member). The speaker 502 may be located or accommodated in the inner space of the housing structure 501 provided by the combination of the second housing 510 and the third housing 520. The speaker 502 may be coupled with the second housing 510 and/or the third housing 520.

According to an embodiment, a flexible member (or a flexible material) such as a rubber may be elastically placed between the second housing 510 and the third housing 520. The flexible member substantially eliminates a gap between the second housing 510 and the third housing 520, thereby reducing the phenomenon of sound generated by the speaker 502 leaking into the gap. The flexible member may contribute to preventing foreign substances such as water or dust introduced from the outside into the first speaker hole 3041 from entering the interior of the electronic device 200 through the second housing 510 and the third housing 520 (e.g., a waterproof structure.

In an embodiment, the front portion 500A and/or the side portion 500C of the speaker module 500 may be provided by a portion of the second housing 510 and a portion of the third housing 520, and the rear portion of the speaker module 500 may be provided by the third housing 520. In some embodiments, a portion of the rear portion of the speaker module 500 may be provided by a second housing 510.

According to an embodiment, the speaker 502 (refer to FIG. 7) may be disposed on or coupled to the second housing 510. In one embodiment, the speaker 502 may be at least partially coupled to the second housing 510 by bonding using an adhesive material (or an adhesive member). The speaker 502 may include a front surface 701, a rear surface 702, and a side surface connecting the front surface 701 and the rear surface 702. The front surface 701 of the speaker 502 may be directed, for example, to the front portion 500A of the speaker module 500 or the front plate 201 (refer to FIG. 4). The rear surface 702 of the speaker 502 may be directed, for example, to the rear portion of the speaker module 500 or to the rear plate 202 (refer to FIG. 4). The speaker 502 may be located between a portion 516 of the second housing 510 and a portion 526 of the third housing 520. The front surface 701 of the speaker 502 may face the portion 516 of the second housing 510, and the rear surface 702 of the speaker 502 may face the portion 526 of the third housing 520. In an embodiment, the first area 700 of the front surface 701 of the speaker 502 (refer to FIG. 7 or 9) may be coupled with a portion 516 of the second housing 510 using an adhesive material (or an adhesive member). The first area 700 may be in the form of a ring adjacent to the edge of the front surface 701 of the speaker 502 and following the edge of the front surface 701. The first area 700 may be in the form of a square ring when viewed from the top of the front surface 701. The form of the first area 700 may vary according to the shape of the speaker 502 without being limited to the square ring form, and in some embodiments may be in the form of a circular ring or not in the form of a ring. The first area 700 corresponding to the adhesive material (or an adhesive member) may be an area in which the speaker 502 does not have a substantial effect when generating sound. The second housing 510 may include a second area 800 corresponding to the first area 700 of the speaker 502 (refer to FIG. 8 or 9). The adhesive material (or an adhesive member) may be disposed between the first area 700 and the second area 800 so that the speaker 502 and the second housing 510 may be combined. In an embodiment, the first area 700 (or the first adhesion area) and the second area 800 (or the second adhesion area) may be substantially parallel to each other, and may include, for example, a plane. The second housing 510 may include a second opening 515 corresponding to the front surface 701 of the speaker 502. The second housing 510 may include a passage structure 902 extending from the front surface 701 of the speaker 502 through the second opening 515 to the first opening 514. The sound generated by the speaker 502 may be guided to the passage structure 902 and emitted to the outside of the speaker module 500 (refer to the path of sound represented by drawing code ‘901’).

According to some embodiments, the speaker module 500 may be located in the electronic device 200 so that the front surface 701 of the speaker 502 is directed to the −y-axis direction (refer to FIG. 2 or 3). In this case, the passage structure 902 including the first opening 514 and the second opening 515 may be modified or changed in a form different from the example of FIG. 9. In one embodiment, depending on the spatial position relationship among the first speaker hole 3041, the first opening 514, and the second opening 515, the passage structure 902 may be implemented in various forms such as a straight passage, a bent passage, or a curved passage. According to some embodiments, the speaker module 500 may be located in the speaker hole provided in the front surface 210A (refer to FIG. 2) of the electronic device 200 (e.g., the second speaker hole of the fourth audio module 305 shown in FIG. 2) or the speaker hole provided in the rear surface 210B (refer to FIG. 3), and in this case, the above-described variation example may also be applied.

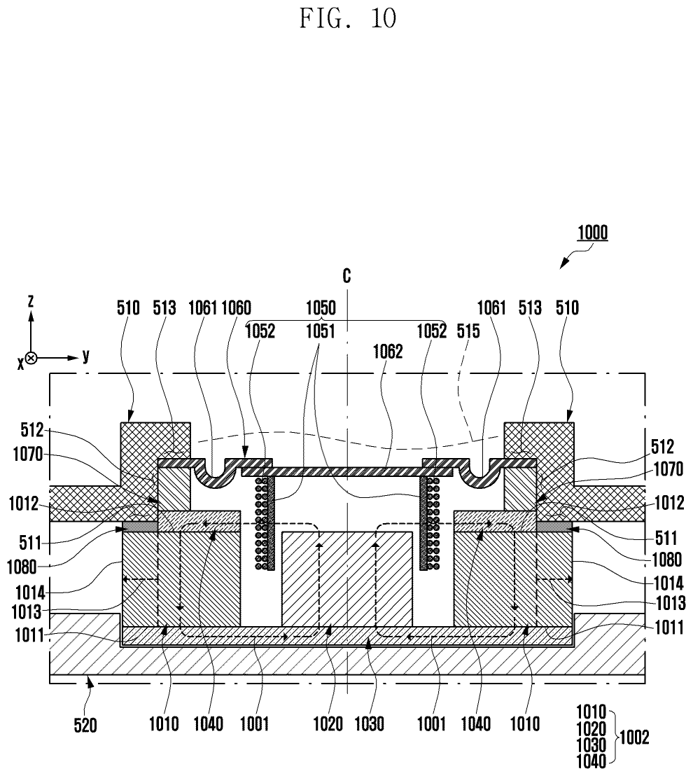

FIG. 10 illustrates a schematic cross-sectional structure 1000 of a portion of a speaker module 500 with respect to line A-A′ in FIG. 6 in one or more embodiments.

With reference to FIGS. 5, 6, 7, 8, 9, and 10, in an embodiment, the speaker module 500 may include a second housing 510, a third housing 520, a magnet 1010, a center pole 1020, a first plate 1030, a second plate 1040, a coil structure 1050, a diaphragm 1060, a support member (or a support or a support structure) 1070, or a first adhesive member (or a first adhesive material) 1080. The speaker 502 of FIG. 9 may include, for example, a magnet 1010, a center pole 1020, a first plate 1030, a second plate 1040, a coil structure 1050, a diaphragm 1060, and/or a support member 1070. The speaker module 500 may include, for example, a third audio module 304 of FIG. 2 or 3.

The magnet 1010 may include a permanent magnet associated with the magnetic field strength of the speaker module 500. The magnet 1010 for example, may be various to be a neodymium magnet, an alnico magnet, or a ferrite magnet. The magnet 1010 may be in the form of a ring surrounding the center pole 1020, for example, in the form of a square ring or in the form of a circular ring. The center pole 1020 may be in the form of a column located inside the magnet 1010 and may be located apart from the magnet 1010. The center pole 1020, for example, may be a form including a lateral 1014 (e.g., a surface facing the inner surface of the magnet 1010) corresponding to the ring type magnet 1010. In one embodiment, if the magnet 1010 is in the form of a square ring, the center pole 1020 may be in the form of a column including four side surfaces. The magnet 1010 and the center pole 1020 may be disposed on the first plate 1030 (e.g., a bottom plate or a rear plate). The magnet 1010 may include the first surface 1011 coupled to the first plate 1030 and a second surface 1012 located opposite to the first surface 1011. In one embodiment, when the magnet 1010 is in the form of a square ring, the first surface 1011 and the second surface 1012 may be surfaces in the form of a square ring. For another example, when the magnet 1010 is in the form of a circular ring, the first surface 1011 and the second surface 1012 may be surfaces in the form of a circular ring. The second plate 1040 (e.g., a top plate or a front plate) may be disposed on the second surface 1012. The second plate 1040, for example, may be in the form of a ring corresponding to a ring type magnet 1010. In an embodiment, the first plate 1030 and the second plate 1040 may include a magnetic material (e.g., a material that magnetizes in a magnetic field) that facilitates magnetic passage. The first plate 1030 and the second plate 1040 may include, for example, SUS430, SUS304, or SPCC comprising an iron (Fe) component. In an embodiment, the center pole 1020 may include a magnetic material. The center pole 1020 may be connected to the second plate 1040 or, in some embodiments, may be provided integrally (or integrated) with the second plate 1040. In some embodiments, the center pole 1020 may be referred to as a protrusion to the first plate 1030.

The coil structure 1050 may include, for example, a coil support member (or a coil support or coil support structure) 1051 and a coil 1052. The coil support member 1051 may be extended into a ring-shaped space between the magnet 1010 and the center pole 1020, and the coil 1052 may be provided by winding a metal wire around the coil support member 1051. In some embodiments, the coil support member 1051 may be referred to as a coil former. The coil support member 1051 may be connected to the diaphragm 1060 (e.g., a corn-type diaphragm or a dome-type diaphragm). Because of the magnetic force generated by the magnet 1010, as shown in the drawing code ‘1001’, a magnetic path (e.g., a magnetic line of force passage or a magnetic flux passage) flowing along the magnet 1010, the second plate 1040, the center pole 1020, and the first plate 1030 may be formed. Sound may occur because of vibration of the diaphragm 1060 because of interaction between the space (e.g., the magnetic field) acting on the magnetic force and the coil structure 1050. Hereinafter, the magnetic field formed in the speaker module 500 because of the magnetic force of the magnet 1010 may be referred to as a fixed magnetic field (or a permanent magnetic field). The coil 1052 supported by the coil support member 1051 may be located between the magnet 1010 and the center pole 1020, or in a gap (e.g., magnetic gap) between the center pole 1020 and the second plate 1040. When an audio signal flows through the coil 1052 in the form of an electric current (e.g., an alternating current), a magnetic line of force induced toward the central axis C in which the coil 1052 is wound, may occur. Because of the interaction between the induced magnetic force and the fixed magnetic field (e.g., Fleming's left-hand law), the coil structure 1050 may be moved in the direction of the central axis C (e.g., in the direction of the +z-axis or the −z-axis). The diaphragm 1060 connected to the coil structure 1050 may vibrate the air because of the movement of the coil structure 1050 to generate sound. The first plate 1030, the second plate 1040, and/or the center pole 1020 may contribute to forming the desired magnetic field distribution. In some embodiments, the first plate 1030, the second plate 1040, or the center pole 1020 may be referred to as a yoke as a component contributing to the formation of the magnetic path 1001. In some embodiments, the first plate 1030, the second plate 1040, or the center pole 1020 may contribute to reducing residual magnetism. In an embodiment, it may be referred to as a magnetic circuit unit 1002, including a magnet 1010, a center pole 1020, a first plate 1030, and a second plate 1040. The magnetic circuit unit 1002 may form a fixed magnetic field to generate force when driving the speaker module 500.

According to some embodiments, the center pole 1020 may include a magnet (e.g., a pole piece). In one embodiment, the center pole 1020 may include a magnet and a magnetic material coupled to the magnet. In this case, the magnetic material of the center pole 1020 may be connected to the first plate 1030 or may be provided integrally (or integrated) with the first plate 1030. For another example, the center pole 1020 may be implemented as a magnet without a magnetic material. The fixed magnetic field of the speaker module 500 may be formed at least partially by the magnet 1010 and the magnet of the center pole 1020.

According to an embodiment, the support member 1070 (or a support or a support structure) may connect the diaphragm 1060 and the magnetic circuit unit 1002. In one embodiment, the support member 1070 may support the diaphragm 1060 between the edges of the diaphragm 1060 and the magnetic circuit unit 1002 (e.g., the second plate 1040). Adhesive members of various polymers may be located between the support member 1070 and the diaphragm 1060, or between the support member 1080 and the magnetic circuit unit 1002. The support member 1070 may include an un-magnetized material to reduce the effect on the fixed magnetic field of the speaker module 500. The support member 1070 may include various materials such as, for example, an amorphous metal such as an amorphous ribbon, a polycarbonate (PC), or an epoxy.

According to an embodiment, the diaphragm 1060 may include a surround (or an edge) 1061 that contributes to efficient air vibration by increasing the vibration area. The surround 1061 has a form that facilitates the vibration of the diaphragm 1060 and may be disposed along the edge adjacent to the edge of the diaphragm 1060. The diaphragm 1060 may include a center cap 1062 located corresponding to the coil structure 1050. The center cap 1062 may contribute to, for example, determining the directionality of the sound wave. The center cap 1062 may serve to prevent foreign substances such as dust from entering the interior of the coil structure 1050 and may be referred to as a dust cap in some embodiments.

According to some embodiments, the diaphragm 1060 may be implemented in an integral form, including a surround 1061 and s center cap 1062. In one embodiment, the surround 1061 and the center cap 1062 may be provided integrally (or integrated).

According to an embodiment, the speaker module 500 may include an elastic structure (e.g., a spider) for restoring the coil structure 1050 to its original position by acting elasticity. The speaker module 500 may include a buffer structure (e.g., a suspension or a damper) for supporting the load of the coil structure 1050 and mitigating the shock generated in the driving of the speaker module 500.

According to an embodiment, the second housing 510 may include a second opening 515 provided corresponding to the diaphragm 1060 so that the diaphragm 1060 can vibrate the air. The sound generated by the vibration of the diaphragm 1060 may be guided to the passage structure 902 (refer to FIG. 9) extending from the second opening 515 to the first opening 514 (refer to FIG. 9) and may be emitted to the outside of the speaker module 500.

According to an embodiment, the third housing 520 may be coupled to the second housing 510 and support the first plate 530.

According to some embodiments, the second housing 510 and/or the third housing 520 may be implemented as at least part of the front case 400 of FIG. 4. In one embodiment, the second housing 510 and/or the third housing 520 may include at least a portion of the first support member 410 (e.g., a bracket) (refer to FIG. 4) of the front case 400 or at least a portion of the side bezel structure 203 (refer to FIG. 4).

According to an embodiment, the second housing 510 may include a first portion 511 corresponding to a portion of the second surface 1012 of the magnet 1010, a second portion 512 corresponding to a portion of the support member 1070, and/or a third portion 513 corresponding to a portion of the diaphragm 1060. In an embodiment, the first portion 511 of the second housing 510 may be coupled with the magnet 1010. In one embodiment, the first adhesive member 1080 (or the first adhesive material) may be located between the second surface 1012 of the magnet 1010 and the first portion 511 of the second housing 510. In one embodiment, the area corresponding to the first adhesive member 1080 of the second surface 1012 of the magnet 1010 may include the first area 700 of FIG. 7 or 9. In one embodiment, the first portion 511 of the second housing 510 corresponding to the first adhesive member 1080 may include the second area 800 of FIG. 8 or 9. The first adhesive member 1080 may include adhesive materials of various polymers. The first adhesive member 1080 may include, for example, a thermal reaction adhesive material, a photoreaction adhesive material, a general adhesive, or a double-sided tape. In some embodiments, the magnet 1010 and the first portion 511 of the second housing 510 may be coupled with various other fastening elements such as bolts. The magnet 1010 may include an extended portion 1013 (hereinafter, an extension portion) corresponding to the first portion 511 of the second housing 510. The extension portion 1013 may extend between the first portion 511 of the second housing 510 and the first plate 1030 and may be coupled to the first portion 511 of the second housing 510. The extension portion 1013 may include, for example, the first area 700 of FIG. 7 or 9. When viewed from above (e.g., in the direction of the −z-axis) of the second opening 515, the first portion 511 of the second housing 510 and the extension potion 1013 of the magnet 1010 may overlap at least partially. The magnet 1010 including an extension portion 1013 corresponding to the first portion 511 of the second housing 510 may contribute to securing the magnetic field strength of the speaker module 500 at a critical level. In one embodiment, the magnet 1010 including the extension portion 1013 may have a greater magnetic force because of the size increase compared to a comparative example that does not have the extension portion 1013. The magnet 1010 including the extension portion 1013 may contribute to the formation of a magnetic line of force through an interaction with the coil 1052 or a fixed magnetic field of the magnetic circuit unit 1002 to reduce the degradation of the output features (e.g., sound pressure) of the speaker module 500 compared to a comparative example that does not have the extension portion 1013. The structure in which the first portion 511 of the second housing 510 is coupled to the extension portion 1013 of the magnet 1010 may facilitate the size expansion of the magnet 1010 and contribute to the slimming of the speaker module 500.

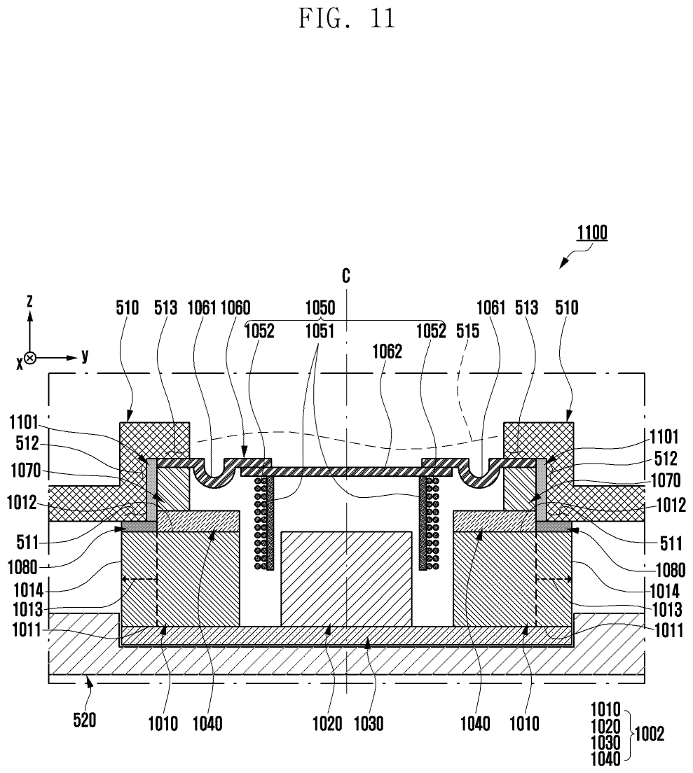

FIG. 11 illustrates a schematic cross-sectional structure 1100 of a portion of a speaker module 500 with respect to line A-A′ of FIG. 6 in another embodiment.

With reference to FIG. 11, in an embodiment, the speaker module 500 may further include a second adhesive member (or a second adhesive material) 1101 located between the second portion 512 of the second housing 510 and the support structure 1070. The second adhesive member 1101 may include, for example, a thermal reaction adhesive material, a photoreaction adhesive material, a general adhesive or a double-sided tape. The second adhesive member 1101 may be connected to the first adhesive member 1180 (or the first adhesive material), or may be provided integrally (or integrated) with the first adhesive member 1180. The second adhesive member 1101 may contribute to the coupling durability of the second housing 510 together with the first adhesive member 1180.

According to some embodiments, the second housing 510 may be extended to cover at least portion of the lateral 1014 of the magnet 1010. The lateral 1014 of the magnet 1010 may be an outer surface surrounding the space between the first surface 1011 and the second surface 1012. In some embodiments, an adhesive member (or an adhesive material) may be located between the lateral 1014 of the second housing 510 and the magnet 1010.

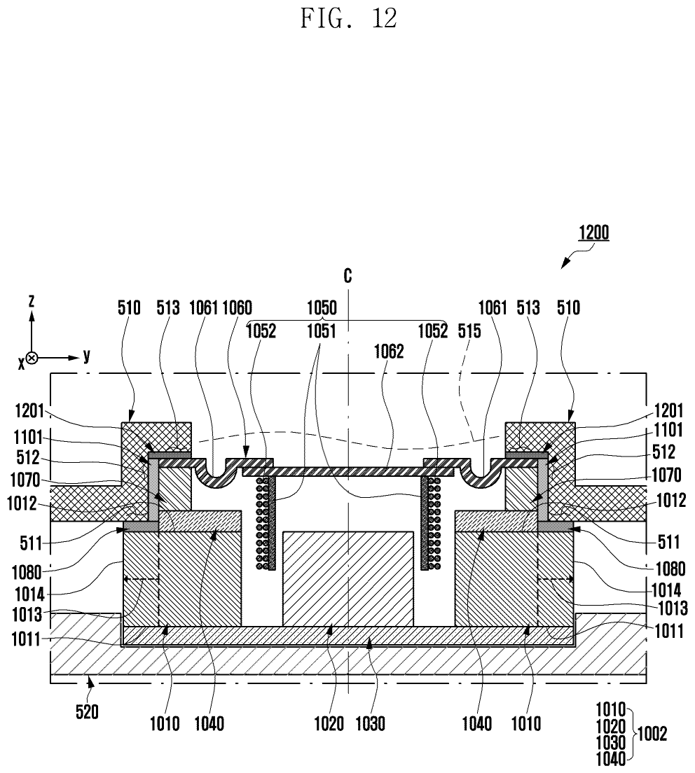

FIG. 12 illustrates a schematic cross-sectional structure 1200 of a portion of a speaker module 500 with respect to line A-A′ of FIG. 6 in another embodiment.

With reference to FIG. 12, in an embodiment, the speaker module 500 may further include a third adhesive member (or a third adhesive material) 1201 located between the third portion 513 of the second housing 510 and the diaphragm 1060. The third adhesive member 1201 may include, for example, a thermal reaction adhesive material, a photoreaction adhesive material, a general adhesive or a double-sided tape. The third adhesive member 1201 may be connected to the second adhesive member 1101 or may be provided integrally (or integrated) with the second adhesive member 1101. In an embodiment, the first adhesive member 1080, the second adhesive member 1101, and the third adhesive member 1201 may be implemented as an integral layer of the same adhesive material. The third adhesive member 1201 may contribute to the coupling durability of the second housing 510 together with the first adhesive member 1080 and/or the second adhesive member 1101.

According to some embodiments, the second adhesive member 1101 may be omitted.

According to some embodiments, the third adhesive member 1201 may be omitted (refer to the example of FIG. 11). In addition, according to some embodiments, the third portion 513 included in the second housing 510 may be provided in a reduced manner differently from the illustrated example. In one embodiment, the third portion 513 may be reduced in the direction of the +y/−y-axis from the central axis C, unlike the illustrated example. The omitted portion of the third portion 513 and the portion of the overlapping support member 1070 may also be omitted. As a result, the vibration area of the diaphragm 560 for air vibration may be expanded.

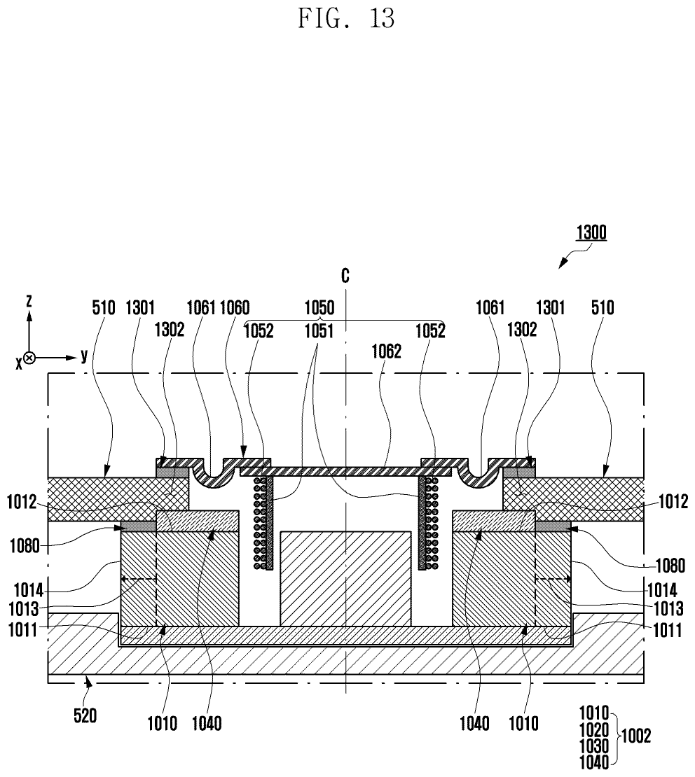

FIG. 13 illustrates a schematic cross-sectional structure 1300 of a portion of a speaker module 500 with respect to line A-A′ of FIG. 6 in another embodiment.

With reference to FIG. 13, compared to the embodiment of FIG. 10, the support member 1070 may be omitted. In an embodiment, a portion 1302 of the second housing 510 may be located between the diaphragm 1060 and the second plate 1040. The portion 1032 of the second housing 510 may not overlap with the surround 1061 of the diaphragm 1060 when viewed from the top of the diaphragm 1060 (e.g., in the direction of the −z-axis). In some embodiments, a portion 1032 of the second housing 510 may overlap with the surround 1061 while being located apart from the surround 1061 not to interfere with the role of surround 1061 when viewed from the top of the diaphragm 1060. An adhesive member (or an adhesive material 1301) may be located between a portion 1302 of the second housing 510 and the diaphragm 1060, and at least a portion of the diaphragm 1060 may be coupled to the second housing 510.

According to some embodiments, a portion of the diaphragm 1060 (e.g., a portion including the surround 1061) may be provided integrally (or integrated) with the second housing 510 and may include a material substantially identical to the second housing 510.

According to some embodiments, an adhesive member (or an adhesive material) may be located between the second housing 510 and the second plate 1040.

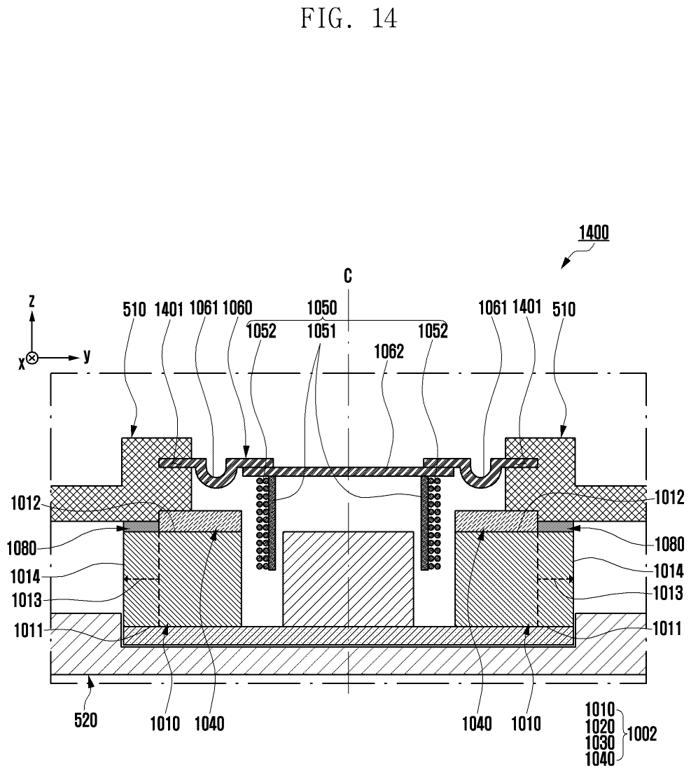

FIG. 14 illustrates a schematic cross-sectional structure 1400 of a portion of a speaker module 500 with respect to line A-A′ of FIG. 6 in another embodiment.

With reference to FIG. 14, compared to the embodiment of FIG. 10, the support member 1070 may be omitted. In an embodiment, the rim portion 1401 (or the border area) of the diaphragm 1060 may be located inside the second housing 510. The second housing 510 may include, for example, a recess or groove in which the rim portion 1401 of the diaphragm 1060 may be inserted. In an embodiment, an adhesive material is disposed between the rim area 1401 of the diaphragm 1060 and the second housing 510, so that the diaphragm 1060 may be coupled to the second housing 510. In some embodiments, the rim area 1401 of the diaphragm 1060 may be fixed to the second housing 510 using various other fastening elements, such as bolt fastening.

According to some embodiments, a portion of the diaphragm 1060 (e.g., a portion including the surround 1061) may be provided integrally (or integrated) with the second housing 510 and may include a material substantially identical to the second housing 510.

According to an embodiment of the disclosure, the electronic device (e.g., the electronic device 200 of FIG. 2) may include a first housing (e.g., the first housing 210 of FIG. 2) that provides at least some of the appearance of the electronic device. The electronic device may include a speaker module (e.g., the speaker module 500 of FIG. 5) located inside the first housing. The speaker module may include a first plate (e.g., the first plate 1030 of FIG. 10) comprising a magnetic material. The speaker module may include a magnet (e.g., the magnet 1010 of FIG. 10) disposed on one surface of the first plate. The speaker module may include a center pole (e.g., the center pole 1020 of FIG. 10) connected to or provided integrally (or integrated) with the first plate. The center pole may be surrounded by the magnet. The speaker module may include a coil structure (e.g., the coil structure 1050 of FIG. 10) including a coil (e.g., the coil 1052 of FIG. 10) inserted in the space between the magnet and the center pole. The speaker module may include a diaphragm (e.g., the diaphragm 1060 of FIG. 10) connected to the coil structure. The speaker module may include a second housing (e.g., the second housing 510 of FIG. 10) that includes an opening (e.g., the opening 515 of FIG. 10) corresponding to the diaphragm. The magnet may include a first surface (e.g., the first surface 1011 of FIG. 10) coupled to the first plate and a second surface (e.g., the second surface 1012 of FIG. 10) located opposite to the first surface. A portion (e.g., the first portion 511 of FIG. 10) of the second housing may be coupled with a portion of the second surface.

According to an embodiment of the disclosure, the electronic device (e.g., the electronic device 200 of FIG. 2) may further include the second surface (e.g., the second surface 1012 of FIG. 10) and the first adhesive member (e.g., the first adhesive member 1080 of FIG. 10) located between the portion (e.g., the first portion 511 of FIG. 10) of the second housing.

According to an embodiment of the disclosure, the magnet (e.g., the magnet 1010 of FIG. 10) may extend between a portion (e.g., the first portion 511 of FIG. 10) of the second housing and the first plate (e.g., the first plate 1030 of FIG. 10) and may include a portion (e.g., an extension portion of FIG. 1013) of the second housing.

According to an embodiment of the disclosure, the electronic device (e.g., the electronic device 200 of FIG. 2) may be located on the second surface between the diaphragm (e.g., the diaphragm 1060 of FIG. 10) and the second surface (e.g., the second surface 1012 of FIG. 10) and further include a second plate (e.g., the second plate 1040 of FIG. 10).

According to an embodiment of the disclosure, the electronic device (e.g., the electronic device 200 of FIG. 2) may further include a support member (e.g., the support member 1070 of FIG. 10) located between the diaphragm (e.g., the diaphragm 1060 of FIG. 10) and the second plate (e.g., the second plate 1040 of FIG. 10).

According to an embodiment of the disclosure, another portion of the second housing (e.g., the second portion 512 of FIG. 10) may be located covering the support member (e.g., the support member 1070 of FIG. 10).

According to an embodiment of the disclosure, the electronic device (e.g., the electronic device 200 of FIG. 2) may further include a second adhesive member (e.g., the second adhesive member 1101 of FIG. 11) located between another portion of the second housing (e.g., the second portion 512 of FIG. 11) and the support member (e.g., the support member 1070 of FIG. 11).

According to an embodiment of the disclosure, the first adhesive member (e.g., the first adhesive member 1080 of FIG. 11) and the second adhesive member (e.g., the second adhesive member 1101 of FIG. 11) may be provided integrally (or integrated).

According to an embodiment of the disclosure, another portion of the second housing (e.g., the third portion 513 of FIG. 12) may be located by covering the diaphragm (e.g., the diaphragm 1060 of FIG. 12).

According to an embodiment of the disclosure, the electronic device (e.g., the electronic device 200 of FIG. 2) may further include a third adhesive member (e.g., the third adhesive member 1201 of FIG. 12) located between another portion of the second housing (e.g., the third portion 513 of FIG. 12) and a diaphragm (e.g., the diaphragm 1060 of FIG. 12).

According to an embodiment of this document, the first adhesive member (e.g., the first adhesive member 1080 of FIG. 12) and the third adhesive member (e.g., the third adhesive member 1201 of FIG. 12) may be provided integrally (or integrated).

According to an embodiment of the disclosure, the center pole (e.g., the center pole 1020 of FIG. 10) may include a magnet.

According to an embodiment of the disclosure, the center pole (e.g., the center pole 1020 of FIG. 10) may include a magnetic material.

According to an embodiment of the disclosure, the center pole (e.g., the center pole 1020 of FIG. 10) may further comprise a magnet coupled to the magnetic material.

According to an embodiment of the disclosure, the magnet (e.g., the magnet 1010 of FIG. 10) may be in the form of a square ring.

According to an embodiment of this document, the speaker module (e.g., the speaker module 500 of FIG. 5) may include a first plate (e.g., the first plate 1030 of FIG. 10) comprising a magnetic material. The speaker module may include a magnet (e.g., the magnet 1010 of FIG. 10) disposed on one surface of the first plate. The speaker module may include a center pole (e.g., the center pole 1020 of FIG. 10) connected to or provided integrally (or integrated) with the first plate. The center pole may be surrounded by the magnet. The speaker module may include a coil structure (e.g., the coil structure 1050 of FIG. 10) including a coil inserted in the space between the magnet and the center pole (e.g., the coil 1052 of FIG. 10). The speaker module may include a diaphragm (e.g., the diaphragm 1060 of FIG. 10) connected to the coil structure. The speaker module may include a housing (e.g., a second housing 510 of FIG. 10) that includes an opening corresponding to the diaphragm (e.g., a second opening 515 of FIG. 10). The magnet may include a first surface (e.g., the first surface 1011 of FIG. 10) coupled to the first plate and a second surface (e.g., the second surface 1012 of FIG. 10) located opposite to the first surface. A portion (e.g., the first portion 511 of FIG. 10) of the housing may be coupled with a portion of the second surface.

According to an embodiment of the disclosure, the speaker module (e.g., the speaker module 500 of FIG. 5) may further include the first adhesive member (e.g., the first adhesive member 1080 of FIG. 10) located between the second surface (e.g., the second surface 1012 of FIG. 10) and a portion (e.g., the first portion 511 of FIG. 10) of the housing.

According to an embodiment of the disclosure, the magnet (e.g., the magnet 1010 of FIG. 10) may include the portion (e.g., the extension portion 1013 of FIG. 10) that extends between a portion of the housing (e.g., the first portion 511 of FIG. 10) and the first plate (e.g., the first plate 1030 of FIG. 10) and is coupled to a portion of the housing.

According to an embodiment of the disclosure, the speaker module (e.g., the speaker module 500 of FIG. 5) may be located on the second surface between the diaphragm (e.g., the diaphragm 1060 of FIG. 10) and the second surface (e.g., the second surface 1012 of FIG. 10) and may further comprise a second plate (e.g., the second plate 1040 of FIG. 10). The speaker module may further include a support member (e.g., the support member 1070 of FIG. 10) located between the diaphragm and the second plate.

According to an embodiment of the disclosure, another portion of the housing (e.g., the second portion 512 of FIG. 11) may be located covering the support member (e.g., the support member 1070 of FIG. 11). The speaker module may further include a second adhesive member (e.g., the second adhesive member 1101 of FIG. 11) located between another portion of the housing and the support member.

The embodiments disclosed in the disclosure and drawings are merely specific examples to easily explain the technical contents and to facilitate the understanding of the embodiments, and are not intended to limit the scope of the embodiments. Therefore, the scope of the one or more embodiments of the disclosure should be construed as including all altered or modified forms in addition to the embodiments disclosed herein.

What is claimed is:

1. An electronic device comprising:
a first housing that is at least a part of an exterior of the electronic device; and
a speaker module located in the first housing,
wherein the speaker module comprises:
a first plate comprising a first magnetic material;
a first magnet disposed on one surface of the first plate;
a center pole connected to the first plate and surrounded by the first magnet;
a coil structure comprising a coil inserted into a gap between the first magnet and the center pole;
a diaphragm connected to the coil structure;
a second housing comprising an opening corresponding to the diaphragm, and
wherein the first magnet comprises:
a first surface coupled to the first plate; and
a second surface positioned opposite to the first surface, and
wherein the second housing is coupled to a first portion of the second surface.

2. The electronic device of claim 1, wherein the center pole and the first plate are integrated.

3. The electronic device of claim 1, further comprising a first adhesive material located between the second surface and a second portion of the second housing.

4. The electronic device of claim 1, wherein the first magnet comprises a third portion that extends between a second portion of the second housing and the first plate, and
wherein the third portion of the first magnet is coupled to the second portion of the second housing.

5. The electronic device of claim 3, further comprising a second plate located on the second surface between the diaphragm and the second surface, and
wherein the second plate comprises a second magnetic material.

6. The electronic device of claim 5, further comprising a support located between the diaphragm and the second plate.

7. The electronic device of claim 6, wherein a fourth portion of the second housing is located by covering the support.

8. The electronic device of claim 7, further comprising a second adhesive material located between a fifth portion of the second housing and the support.

9. The electronic device of claim 8, wherein the first adhesive material and the second adhesive material are integrated.

10. The electronic device of claim 3, wherein a sixth portion of the second housing is configured to cover the diaphragm.

11. The electronic device of claim 10, further comprising a third adhesive material located between a seventh portion of the second housing and the diaphragm.

12. The electronic device of claim 11, wherein the first adhesive material and the third adhesive material are integrated.

13. The electronic device of claim 1, wherein the center pole comprises a second magnet.

14. The electronic device of claim 1, wherein the center pole comprises a third magnetic material.

15. The electronic device of claim 14, wherein the center pole further comprises a second magnet coupled to the third magnetic material.

16. The electronic device of claim 1, wherein the first magnet is a square ring.
